(19) United States
(12) Patent Application Publication
(10) Pub. No.: US 2007/0193046 A1
(43) Pub. Date: Aug. 23, 2007

(54) Digital Spirit Level

(76) Inventor: David Arlinsky, Atlit (IL)

Correspondence Address: NATH & ASSOCIATES, 112 South West Street, Alexandria, VA, 22314, US

(21) Appl. No.: 10/591,803

(22) PCT Filed: Mar. 10, 2005
(86) PCT No.: PCT/IL05/00278

§ 371 Date: Sep. 6, 2006

Related U.S. Application Data
(60) Provisional application No. 60/590,938, filed on Jul. 26, 2004.

(30) Foreign Application Priority Data
Mar. 13, 2004 (IL) 160860

(51) Int. Cl. G01C 9/06

(52) U.S. Cl. 33/366.11

(57) ABSTRACT

A digital spirit level for displaying inclination measurements of vertical surfaces upright relative to 0° horizontal for facing a user holding the digital spirit level against a vertical surface for facilitating straight on reading of its inclination measurement. The inclination measurements are preferably displayed relative to 0° vertical as opposed to 0° horizontal. The inclination measurements are displayed on either a display screen including a pair of orthogonal seven segment arrays or a graphic display screen for displaying inclination measurements upright relative to 0° horizontal irrespective of the attitude of the digital spirit level thereto. The digital spirit level preferably includes either a self-calibrating capacitative inclination measurement module or alternatively a closed loop inclination measurement module employing an electric field for maintaining a meniscus of a dielectric liquid at a predetermined reference position.

### CROSS-REFERENCE TO RELATED APPLICATIONS

This application claims the benefit of U.S. Provisional Application No. 60/590,938, filed Jul. 26, 2004; and

This application is the United States National Stage filing of PCT Application PCT/I12005/000278 having an international filing date of Mar. 10, 2005.

### FIELD OF THE INVENTION

The invention is in the field of digital spirit levels.

### BACKGROUND OF THE INVENTION

Digital spirit levels have either a single leveling surface or a pair of opposite and parallel leveling surfaces for placing on a surface, a horizontal bubble vial for indicating the inclination of a surface relative to 0° horizontal, a vertical bubble vial for indicating the inclination of a surface relative to 0° vertical, and an inclination measurement module for measuring inclination measurements for digital display purposes. FIGS. 1-4 show a conventional single sided digital spirit level displaying inclination measurements perpendicular to its leveling surface, thereby inconveniencing users in the case of vertical surfaces in which the inclination measurements appear sideways to a user holding a digital spirit level (see FIGS. 3 and 4). Moreover, conventional digital spirit levels further inconvenience users by requiring calibration before use for nullifying offsets which may vary over time due to handling, changes in ambient temperature, and the like.

### SUMMARY OF THE INVENTION

The present invention is for a digital spirit level for displaying inclination measurements of vertical surfaces upright relative to 0° horizontal as opposed to sideways as hitherto displayed for facilitating user reading of same since a user holding the digital spirit level against a vertical surface can read its inclination measurement straight on instead of having to incline his head. Moreover, the inclination measurements are preferably measured relative to 0° vertical as opposed to 0° horizontal, thereby further facilitating user reading of same. The inclination measurements are displayed on a display screen implemented by either a pair of orthogonal seven segment arrays or a graphic display screen for displaying inclination measurements upright relative to 0° horizontal irrespective of the attitude of the digital spirit level thereto. The digital spirit level may include a conventional capacitative inclination measurement module, for example, as illustrated and described in inter alia U.S. Pat. No. 4,912,662 to Butler et al., and U.S. Pat. No. 5,335,190 to Nagle et al. or preferably a self-calibrating capacitative inclination measurement module for determining inclination measurements of surfaces as a function of the capacitances of a pair of variable capacitors having capacitances proportional to an inclination of a surface and inversely affected by a change in its inclination relative to 0° horizontal such that one of the capacitor's capacitance increases whilst the other capacitor's capacitance decreases due to a change in the inclination of a surface. Alternatively, the digital spirit level may include a closed loop inclination measurement module employing an electric field for maintaining a meniscus of a dielectric liquid at a predetermined reference position.

### BRIEF DESCRIPTION OF THE DRAWINGS

In order to understand the invention and to see how it can be carried out in practice, preferred embodiments will now be described, by way of non-limiting examples only, with reference to the accompanying drawings in which similar parts are likewise numbered, and in which:

FIG. 1 is a pictorial view showing the placement of a conventional digital spirit level on an 0.3° inclined near horizontal surface for displaying an 0.3° inclination measurement upright relative to 0° horizontal;

FIG. 2 is a pictorial view showing the placement of FIG. 1 digital spirit level against an 0.3° inclined near horizontal ceiling for displaying an 0.3° inclination measurement upright relative to 0° horizontal;

FIG. 3 is a pictorial view showing the placement of FIG. 1 digital spirit level against a 1.0° inclined near vertical surface for inconveniently displaying an 89° inclination measurement sideways relative to 0° horizontal;

FIG. 4 is a pictorial view showing the placement of FIG. 1 digital spirit level against an opposite 1.0° inclined near vertical surface for inconveniently displaying an 89° inclination measurement sideways relative to 0° horizontal;

FIG. 5 is a pictorial view showing the placement of a digital spirit level in accordance with the present invention on an 0.3° inclined near horizontal surface for displaying an 0.3° inclination measurement upright relative to 0° horizontal;

FIG. 6 is a pictorial view showing the placement of FIG. 5 digital spirit level against an 0.3° inclined near horizontal ceiling for displaying an 0.3° inclination measurement upright relative to 0° horizontal;

FIG. 7 is a pictorial view showing the placement of FIG. 5 digital spirit level against an 1.0° inclined near vertical surface for displaying an 1° inclination measurement upright relative to 0° horizontal;

FIG. 8 is a pictorial view showing the placement of FIG. 5 digital spirit level against an opposite 1.0° inclined near vertical surface for displaying an 1° inclination measurement upright relative to 0° horizontal;

FIG. 9 is a pictorial view showing the placement of FIG. 5 digital spirit level with a graphic display screen on a 10° inclined surface for displaying an 10° inclination measurement upright relative to 0° horizontal;

FIG. 10 is a pictorial view showing the placement of FIG. 5 digital spirit level with a graphic display screen on a 80° inclined surface for displaying an 10° inclination measurement upright relative to 0° horizontal;

FIG. 11 is a schematic diagram of a self-calibrating capacitative inclination measurement module of FIG. 5 digital spirit level including a pair of variable capacitors;

FIG. 12 are graphs of the capacitances of the variable capacitors of FIG. 11 self-calibrating capacitative inclination measurement module;

FIG. 13 is a schematic diagram of a first embodiment of a pair of variable capacitors of FIG. 11 self-calibrating capacitative inclination measurement module;

FIG. 14 is a transparent view of a second embodiment of a pair of variable capacitors of FIG. 11 self-calibrating capacitative inclination measurement module;

FIG. 15 is a schematic diagram of a third embodiment of a pair of variable capacitors of FIG. 11 self-calibrating capacitative inclination measurement module;

FIG. 16 is a schematic diagram of a closed loop inclination measurement module of FIG. 5 digital spirit level;

FIG. 17 is a schematic diagram of a first preferred embodiment of FIG. 16 closed loop inclination measurement module; and

FIG. 18 is a schematic diagram of a second preferred embodiment of FIG. 16 closed loop inclination measurement module.

### DETAILED DESCRIPTION OF PREFERRED EMBODIMENTS OF THE PRESENT INVENTION

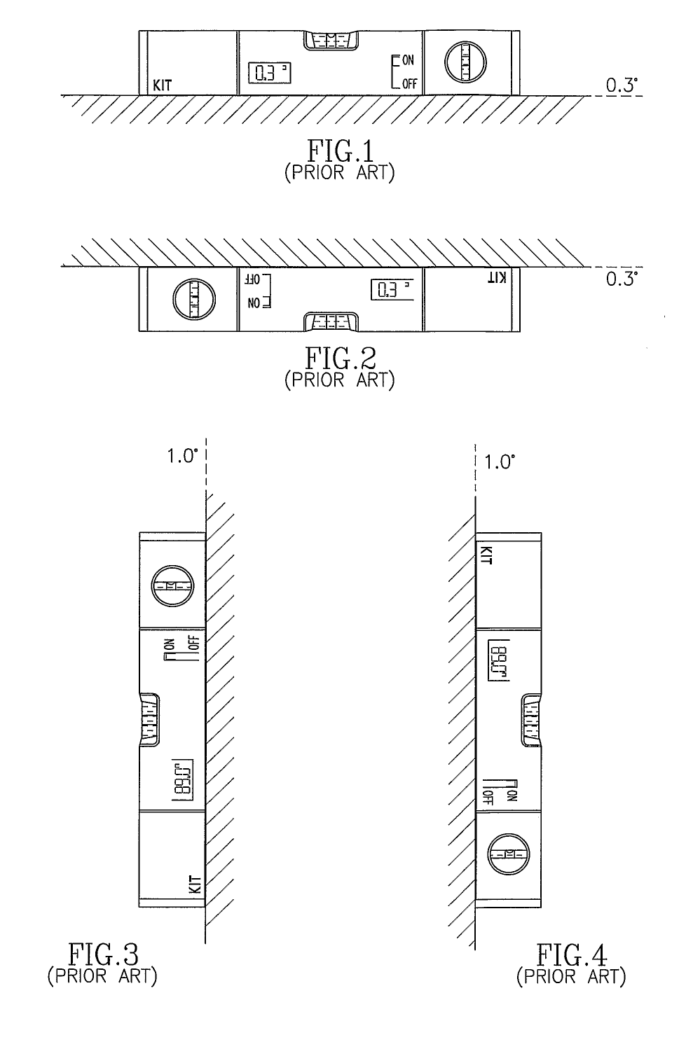

FIG. 1 shows a single sided digital spirit level 10 including a housing 11 with a leveling surface 12 for placing on a surface, a horizontal bubble vial 13 for indicating the inclination of a surface relative to 0° horizontal, and a vertical bubble vial 14 for indicating the inclination of a surface relative to 0° vertical. The digital spirit level 10 also includes a regulated battery power supply 16, a controller 17, an inclination measurement module 18 for measuring inclination measurements of surfaces, a pendulum based or tilt switch attitude detection module 19 for detecting the attitude of the digital spirit level 10 relative to 0° horizontal, and a display driver 21 for displaying inclination measurements on a display screen 22. The display screen 22 may also have a low battery icon, ↑ and ↓ arrows for indicating the direction of correction relative to 0° horizontal or 0° vertical, and the like. The digital spirit level 10 also includes a user interface panel 23 including an 0° H/0° V selector 24 for enabling a user to select displaying inclination measurements relative to 0° horizontal or 0° vertical, an °/% selector 26 for enabling a user to select displaying inclination measurements in degrees or percentages, and the like.

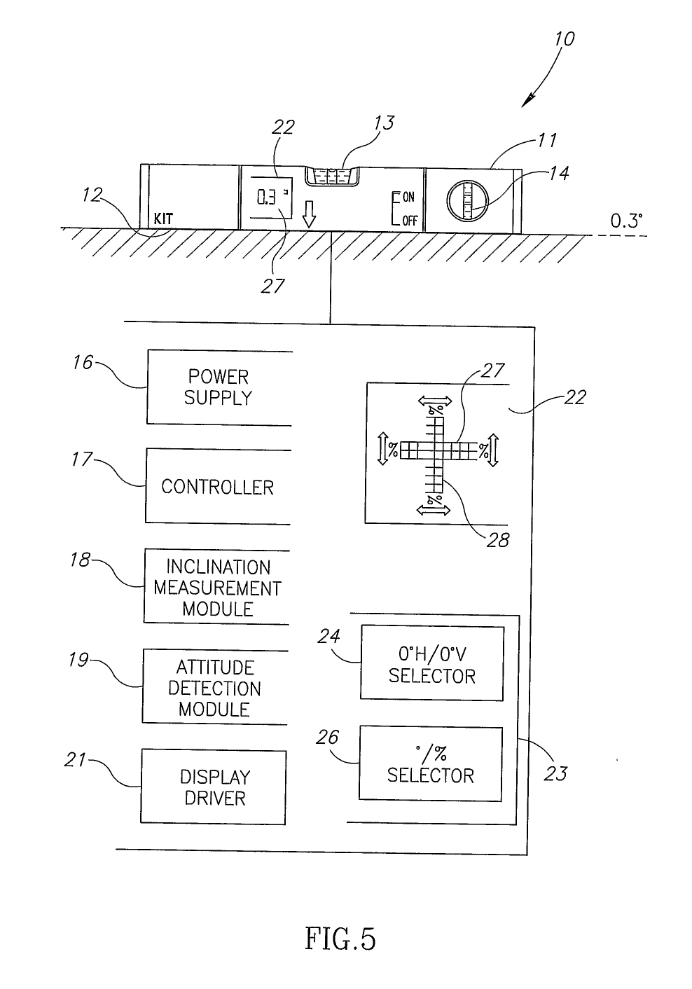

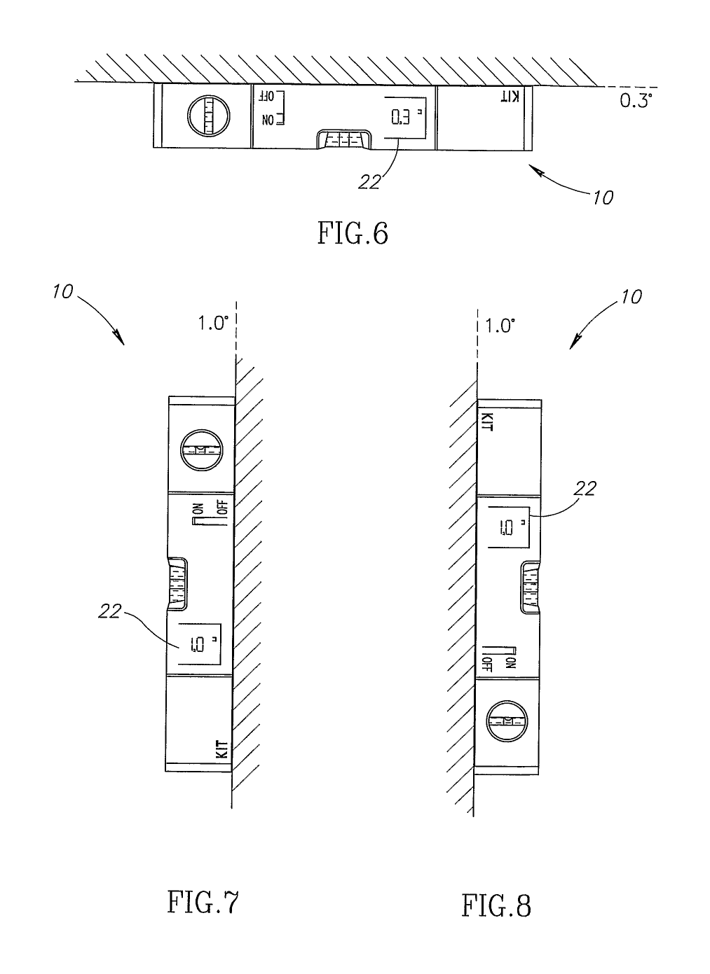

The display screen 22 can be implemented by a pair of orthogonal seven segment arrays 27 and 28 for displaying inclination measurements perpendicular to the leveling surface 12 and parallel to the leveling surface 12, respectively. The seven segment array 27 is typically employed for displaying inclination measurements up to a 45° changeover inclination relative to 0° horizontal (see FIGS. 5 and 6) and the seven segment array 28 for steeper surfaces including near vertical surfaces whereupon the inclination measurements appear upright relative to 0° horizontal (see FIGS. 7 and 8). The attitude detection module 19 is employed for providing an input signal for determining whether to display inclination measurements on either the seven segment array 27 or the seven segment array 28 for inclinations close to the 45° changeover inclination which may lead to a user passing through the 45° changeover inclination several times which otherwise would undesirably cause the inclination measurement to be displayed alternately on the seven segment array 27 and the seven segment array 28.

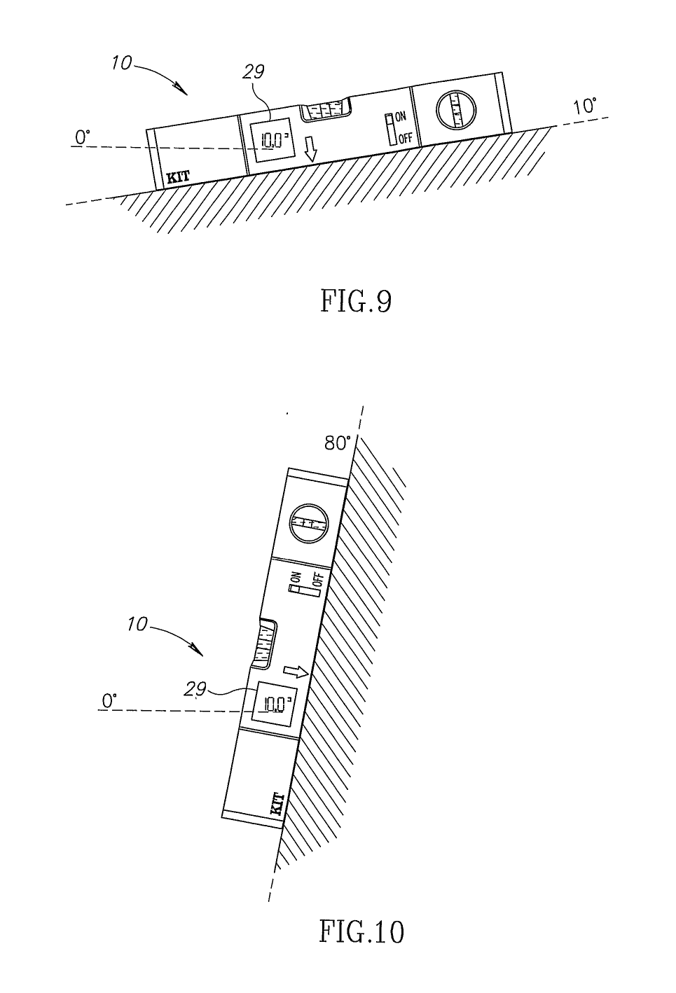

Alternatively, the display screen 22 can be implemented by a graphic display screen 29 for displaying inclination measurements upright relative to 0° horizontal irrespective of the attitude of the digital spirit level 10 thereto (see FIGS. 9 and 10).

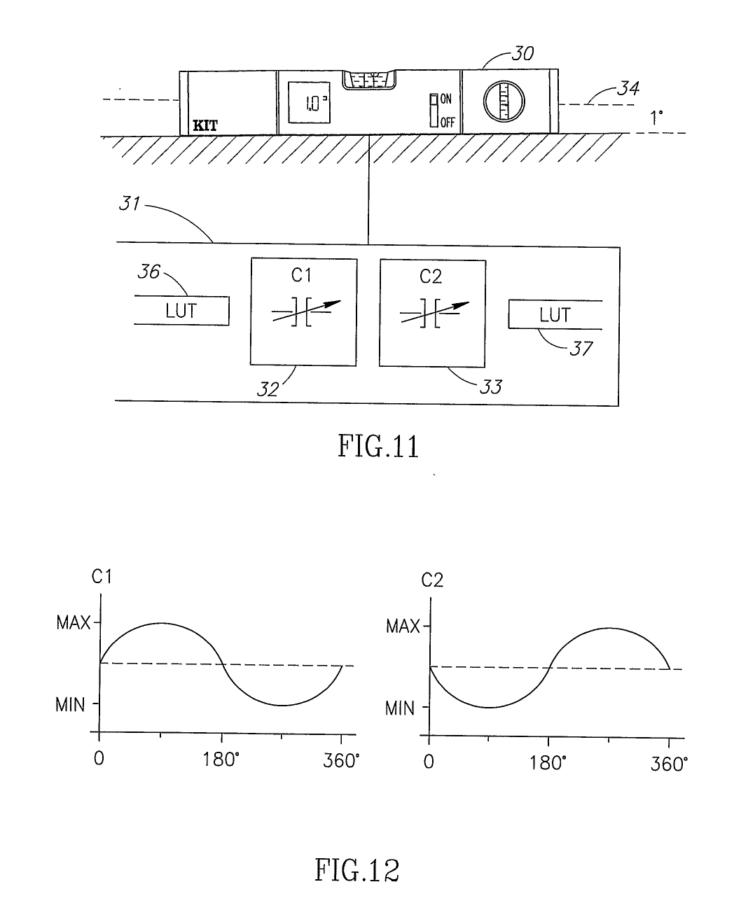

FIG. 11 shows a digital spirit level 30 similar to the digital spirit level 10 and therefore similar parts are numbered likewise. The digital spirit level 30 includes a self-calibrating capacitative inclination measurement module 31 for determining the inclination measurement of a surface as a function of the capacitances of a pair of variable capacitors 32 and 33. The capacitors 32 and 33 each have a pair of parallel metal plates deployed co-directional with a longitudinal axis 34 of the digital spirit level 30 and partially filled with a dielectric liquid comparable to liquids in conventional digital spirit levels insofar as it remains liquid over a temperature range including <0° C. for cold weather use of the digital spirit level 50, reacts quickly to changes in inclination, and the like. The capacitors 32 and 33 each have at least one metal plate whose area submerged under the dielectric liquid changes as a function of the inclination of a surface relative to 0° horizontal, thereby changing their capacitances C1 and C2 in accordance with the relationship C=εA/d where ε is the coefficient of the dielectric liquid, A is the submerged area of a capacitor's metal plates, and d is the separation between its metal plates. The capacitors 32 and 33 are designed such that their capacitances C1 and C2 are inversely affected by a change in the inclination of a surface relative thereto, thereby inherently nullifying any offsets and rendering the inclination measurement module 31 self-calibrating. The capacitors 32 and 33 are arranged such that they have the same capacitance at 0° and 180° relative to 0° horizontal for increasing sensitivity when measuring inclination measurements of near horizontal surfaces. Accordingly, the capacitor 32 has a maximum capacitance at 90° relative to 0° horizontal decreasing to a minimum capacitance at 270° relative to 0° horizontal whilst conversely the capacitor 33 has a minimum capacitance at 90° relative to 0° horizontal increasing to a maximum capacitance at 270° relative to 0° horizontal. Look Up Tables (LUTs) 36 and 37 are provided for respectively storing the capacitances C1 and C2 over 360° relative to 0° horizontal at, say, 1° increments.

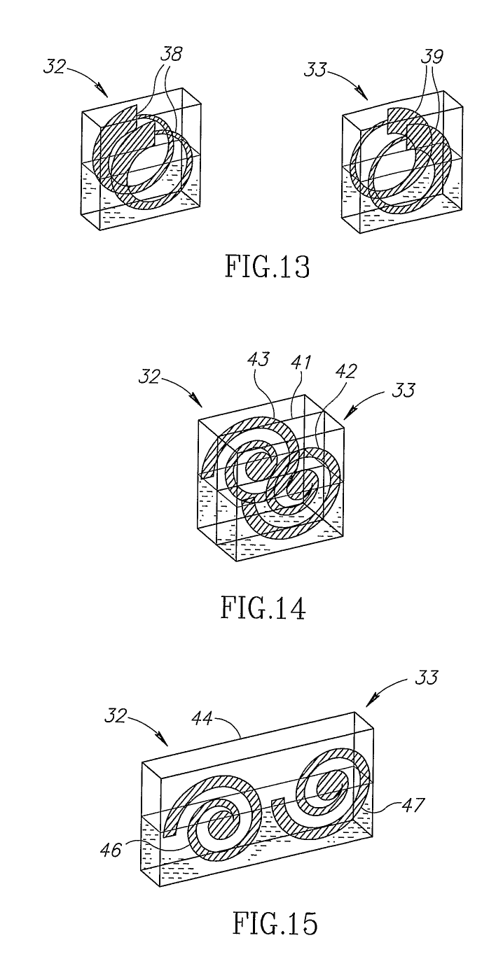

FIG. 13 shows a first embodiment of the inclination measurement module 31 including discrete capacitors 32 and 33. The capacitors 32 and 33 each have a pair of annular shaped metal plates 38 and 39 (shown shaded) each having a radial width continuously increasing from a minimum width to a maximum width over a full 360° . The metal plates 38 and 39 can be printed on suitable electrically insulating plastic material substrates. The capacitors 32 and 33 can be staggered along the longitudinal axis 34 or deployed side by side widthwise in the digital spirit level 30 depending on design considerations.

FIG. 14 shows a second embodiment of the inclination measurement module 31 including capacitors 32 and 33 sharing a common metal plate 41 and respectively having spiral shaped metal plates 42 and 43 (shown shaded) on either side of the common metal plate 41 and inverted with respect to each other.

FIG. 15 shows a third embodiment of the inclination measurement module 31 including capacitors 32 and 33 sharing a common metal plate 44 and respectively having adjacent spiral shaped metal plates 46 and 47 (shown shaded) inverted with respect to each other.

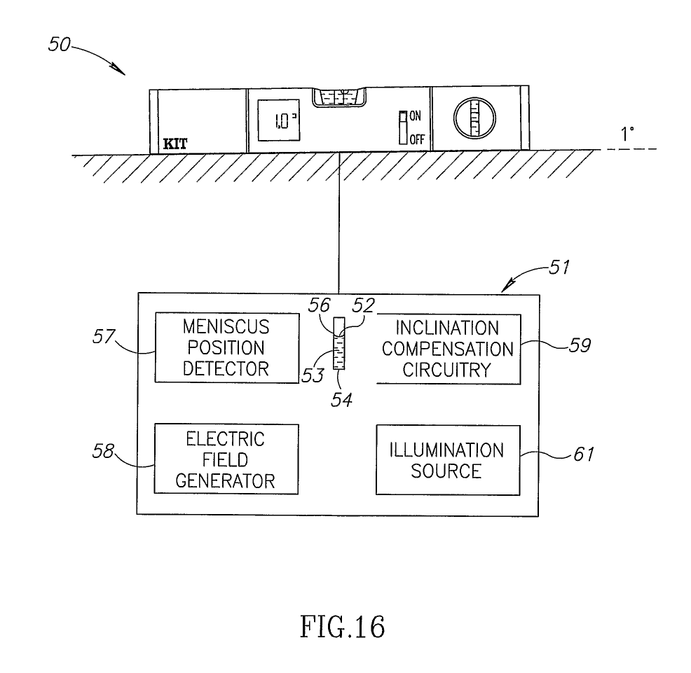

FIG. 16 shows a digital spirit level 50 similar to the digital spirit level 10 and therefore similar parts are likewise numbered. The digital spirit level 50 includes a closed loop inclination measurement module 51 for determining an inclination measurement of a surface as a function of an electric field for maintaining a meniscus 52 of a dielectric liquid 53 in a dielectric liquid containing vessel 54 at a pre-determined reference position 56 when the digital spirit level 50 is placed on a horizontal surface. The inclination measurement module 51 includes a meniscus position detector 57 for optically detecting the instantaneous position of the meniscus 52 relative to its reference position 56, an electric field generator 58 for generating an electrical field for inducing an electric charge for controlling the position of the meniscus 52 relative to its reference position 56, and an inclination compensation circuitry 59 for controlling the electric field generator 58 for maintaining the meniscus 52 at its reference position 56. The inclination measurement module 51 also preferably includes an illumination source 61 for illuminating the liquid containing vessel 54.

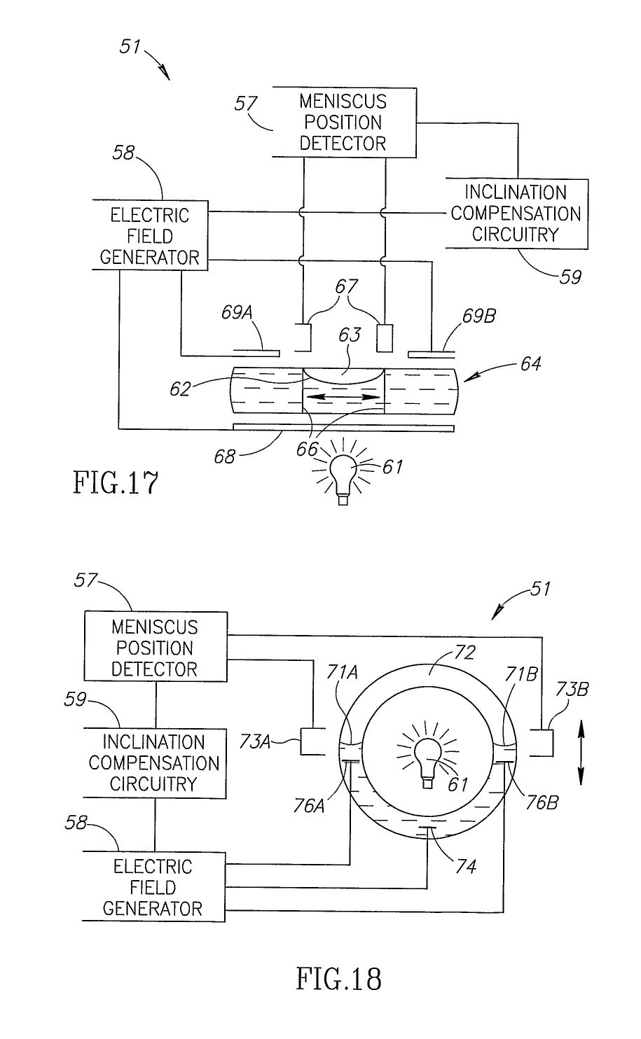

FIG. 17 shows an inclination measurement module 51 for maintaining a meniscus 62 of an air bubble 63 in a bubble vial 64 at a predetermined reference position between a pair of spaced apart reference markings 66 on placement of the digital spirit level 50 on a horizontal surface. The meniscus position detector 57 includes a pair of photo-detectors 67 deployed at the reference markings 66. The electrical field generator 58 is in electrical connection with an earth node 68 largely co-extensive with the bubble vial 64 along its longitudinal axis, and a pair of positive nodes 69A and 69B deployed parallel to the earth node 68 at opposite ends of the bubble vial 64 for generating an electric field for maintaining the meniscus 62 at its predetermined reference position.

FIG. 18 shows an inclination measurement module 51 for maintaining a pair of meniscuses 71A and 71B on opposite sides of a dielectric liquid filled toroid 72 at predetermined reference positions on placement of the digital spirit level 50 on a horizontal surface. The meniscus position detector 57 includes a photo-detector 73A for detecting the position of the meniscus 71A relative to its reference position, and a photo-detector 73B for detecting the position of the meniscus 71B relative to its reference position. The electrical field generator 58 is in electrical connection with an earth node 74 deployed at the bottom of the toroid 72 and a pair of positive nodes 76A and 76B deployed approximate the reference positions of the meniscuses 71A and 71B for generating an electric field for maintaining the meniscuses 71A and 71B at their predetermined reference positions.

While the invention has been described relative to a limited number of embodiments, it will be appreciated that many variations, modifications, and other applications of the invention can be made within the scope of the appended claims.

1. A digital spirit level comprising a housing with a leveling surface for placing on a surface, an inclination measurement module for measuring an inclination measurement of a surface, and a display driver for displaying inclination measurements of vertical surfaces upright relative to 0° horizontal for facing a user holding the digital spirit level against a vertical surface for facilitating straight on reading of its inclination measurement.

2. The level according to claim 1 wherein said display driver displays inclination measurements of vertical surfaces relative to 0° vertical instead of 0° horizontal for upright display relative to 0° horizontal.

3. The level according to claim 2 wherein said display driver drives a display screen including a pair of orthogonal seven segment arrays for displaying inclination measurements of surfaces where a first seven segment array of said pair of orthogonal seven segment arrays displays inclination measurements of surfaces perpendicular to said leveling surface and a second seven segment array of said pair of orthogonal seven segment arrays displays inclination measurements of surfaces parallel to said leveling surface.

4. The level according to claim 3 and further comprising an attitude detection module for detecting the attitude of the digital spirit level relative to 0° horizontal for providing an input signal for determining whether to display an inclination measurement of a surface whose inclination is close to a changeover inclination on either said first seven segment array or said second seven segment array.

5. The level according to claim 2 wherein said display driver drives a graphic display screen for displaying inclination measurements upright relative to 0° horizontal irrespective of the attitude of said leveling surface thereto.

6. The level according to claim 1 wherein said display driver drives a display screen including a pair of orthogonal seven segment arrays for displaying inclination measurements of surfaces where a first seven segment array of said pair of orthogonal seven segment arrays displays inclination measurements of surfaces perpendicular to said leveling surface and a second seven segment array of said pair of orthogonal seven segment arrays displays inclination measurements of surfaces parallel to said leveling surface.

7. The level according to claim 6 and further comprising an attitude detection module for detecting the attitude of the digital spirit level relative to 0° horizontal for providing an input signal for determining whether to display an inclination measurement of a surface whose inclination is close to a changeover inclination on either said first seven segment array or said second seven segment array.

8. The level according to claim 1 wherein said display driver drives a graphic display screen for displaying inclination measurements upright relative to 0° horizontal irrespective of the attitude of said leveling surface thereto.
